(19) United States
(12) Patent Application Publication
(10) Pub. No.: US 2007/0070593 A1
(43) Pub. Date: Mar. 29, 2007

(54) Fastening mechanism

(75) Inventors: Wei Wu, Taipei (TW); San-Feng Lin, Taipei (TW); Chih-Yung Chi, Taipei (TW)

Correspondence Address: BIRCH STEWART KOLASCH & BIRCH, PO BOX 747, FALLS CHURCH, VA, 22040-0747, US

(73) Assignee: ASUSTeK COMPUTER INC.

(21) Appl. No.: 11/490,091

(22) Filed: Jul. 21, 2006

(30) Foreign Application Priority Data
Sep. 27, 2005 (TW) 94133598

(51) Int. Cl. G06F 1/16

(52) U.S. Cl. 361/683

(57) ABSTRACT

A fastening mechanism includes a first engagement element, a movable plate and a press button. The first engagement element is attached to a display device. The movable plate is disposed movably within a casing and has a second engagement element for engaging with and disengaging from the first engagement element when the display device covers the casing. The press button is mounted on the movable plate for synchronous movement therewith. Inward and outward movements of the movable plate together with the press button with respect to the casing result in engagement of the first and second engagement elements and disengagement of the first and second engagement elements.

### FIELD OF THE INVENTION

The invention relates to a fastening mechanism, and more particularly to a fastening mechanism for use in a notebook computer.

### BACKGROUND OF THE INVENTION

Referring to FIG. 1, a conventional notebook computer is shown to include a main body 11 and a display 10 that is connected pivotally to the main body 11 and that is movable between used and non-used positions with respect to the main body 11. Some electronic modules, such as a processor, memory devices, interface cards, are disposed within the main body 11.

When the conventional notebook computer is disposed at the non-used position, a fastening device 12 fastens the display 10 onto the main body 11 in order to facilitate transport or carry along with the user. In use, the fastening device 12 is released to permit the display 10 to move toward the used position, as best shown in FIG. 1.

The fastening device 12 is disposed in the main body 11, and generally includes a latch member 121 fixed to the display 10 and projecting outwardly therefrom. When the conventional notebook computer is disposed at the non-used position, the latch member 121 extends into an engagement hole 111 in the main body 11 in order to engage with the other elements of the fastening device 12, thereby immobilizing the display 10 with respect to the main body 11.

FIG. 2A shows a sectional view of the conventional notebook computer taken along the A-A line in FIG. 1. In order to better understanding of the fastening device 12 employed in the conventional notebook computer, only a portion of the display 10 is shown.

As shown in FIG. 2A, the fastening device 12 further includes a locking member 122 and a compression spring 123.

The locking member 122 may have different configurations in order to complement with different designs according to its function and purposes. The compression spring 123 is disposed inboard to the locking member 122 in order to provide restoration force of the locking member 122 so as to return to its initial condition. The locking member 122 has a rear section 1221 in contact with the compression spring 123, a front section 1222 exposed from the main body 11, and an engaging tongue 1223 projecting from the rear section 1221 towards the front section 1222 for engaging a latch hole 1210 in the latch member 121 when the display 10 is disposed at the non-used position.

Referring to 2B, when it is desired to use the conventional notebook computer, the locking member 12 is pressed inward against the urging action of the compression spring 123, which, in turn, results in retraction of the tongue 1223 from the latch hole 1210 in the latch member 121, thereby permitting turning of the display 10 to the used position. Removal of the applied force permits extension of the tongue 1223 into the latch hole 1210 in the latch member 121 due to the restoration force of the compression spring 123.

The front section 1222 of the locking member 122 is generally exposed to the exterior of the main body 11. In order to match with the color of the main body 11, the front section 1222 of the locking member 122 is usually electroplated, such as Cr (chromium) metal.

FIG. 3 is a perspective view of the locking member 122. The locking member 122 is a one-piece element and is made from a plastic material that can be electroplated, such as ABS (Acrylonitrile Butadiene Styrene). The front section 1222 of the locking member 122 must be coated with a metal layer to complement with the color of the main body 11, and not the rear section 1221.

To prevent the rear section 1221 of the locking member 121 from being coated with the metal layer, the rear section 1221 is firstly treated in such a manner to be coated by an anti-plating layer. Under this condition, only the front section 1222 of the locking member 121 will be coated with the metal layer during the electroplating process. However, formation of the anti-plating layer on the rear section 1221 of the locking member 121 results in additional friction force during movement of the locking member 121 relative to the main body 11, thereby causing hindrance to smooth movement of the locking member 121. In addition, it is relatively difficult to control the desired thickness of the anti-plating layer during the formation.

### SUMMARY OF THE INVENTION

It is the object of the present invention is to provide a fastening mechanism for use in the notebook computer or a flip device. The fastening mechanism of simple structure is clear of the disadvantage encountered during use of the conventional notebook computer.

According to a aspect of the present invention, the fastening mechanism for fastening a device shielding lid pivotally to a casing in a flip device is disclosed. The fastening mechanism includes a first engagement element, a movable plate and a press button. The first engagement element is attached to the shielding lid. The movable plate is disposed movably within a casing, and has a second engagement element for engaging with and disengaging from the first engagement element when the shielding lid covers the casing. The press button is mounted on the movable plate for synchronous movement therewith. Inward and outward movements of the movable plate together with the press button with respect to the casing result in engagement of the first and second engagement elements and disengagement of the first and second engagement elements.

In a second aspect of the present invention, a fastening mechanism is provided for fastening a display device pivotally to a CPU casing in a notebook computer. The fastening mechanism includes a first engagement element, a movable plate and a press button. The first engagement element is adapted to be attached to the display device. A movable plate is adapted to be disposed movably within the casing and has a second engagement element for engaging with and disengaging from the first engagement element when the casing is to be covered by the display device. The press button is mounted on the movable plate for synchronous movement therewith. Inward and outward movements of the movable plate together with the press button with respect to the casing result in engagement of the first and second engagement elements and disengagement of the first and second engagement elements.

### BRIEF DESCRIPTION OF THE DRAWINGS

Other features and advantages of this invention will become more apparent in the following detailed description of the preferred embodiment of this invention, with reference to the accompanying drawings, in which:

FIG. 1 is a perspective view of a conventional notebook computer;

FIGS. 2A and 2B are sectional views taken along the A-A line to illustrate how a fastening device fastens a display pivotally to a CPU casing in the conventional notebook computer;

FIG. 3 is a perspective view of a locking member employed in the fastening device of the conventional notebook computer;

FIG. 4 is an exploded view of a fastening mechanism employed in the notebook computer of the present invention;

FIG. 5 is a perspective view of the notebook computer of the present invention;

FIGS. 6 and 7 are sectional views taken along the A-A1 line to illustrate how a fastening mechanism fastens a shielding lid pivotally to a casing of the notebook computer of the present invention;

FIG. 8 is a bottom view illustrating how the components of the fastening mechanism are mounted to the shielding lid and the casing of the notebook computer of the present invention; and

FIG. 9 is a perspective bottom view of the casing of the notebook computer of the present invention.

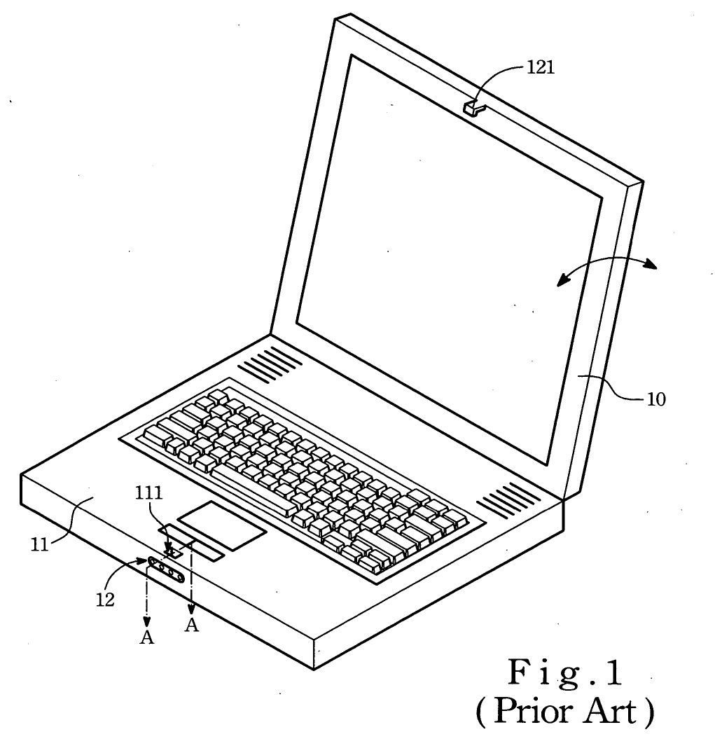

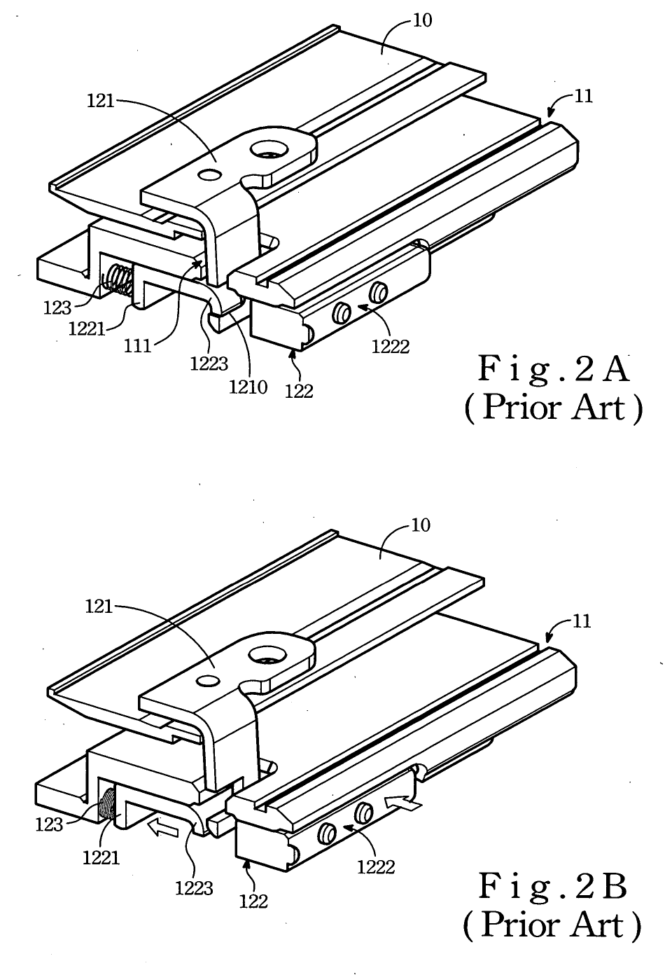

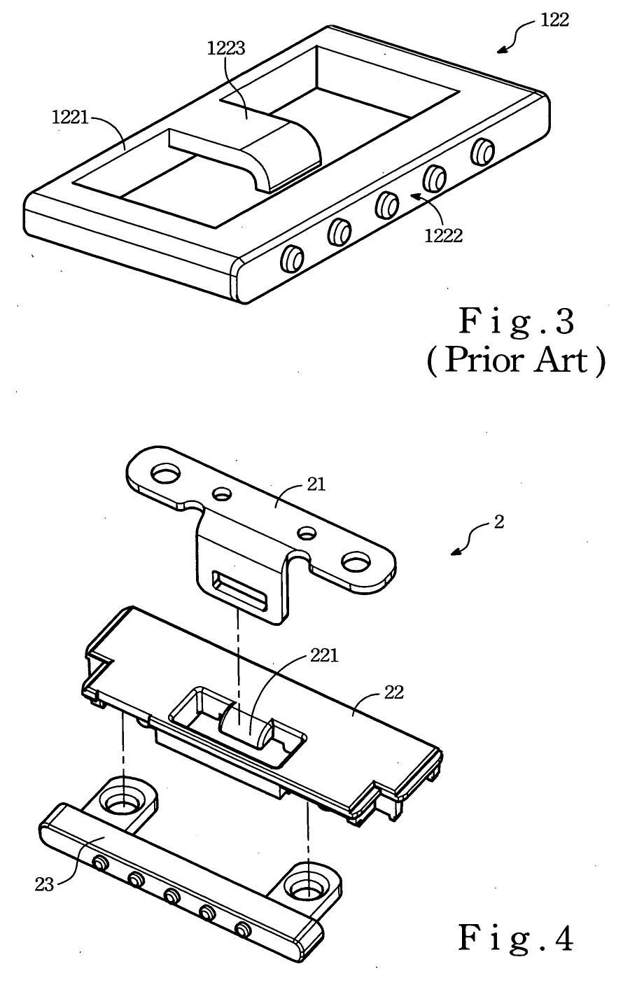

### DETAILED DESCRIPTIONS OF THE PREFERRED EMBODIMENT

FIG. 4 shows an exploded view of a fastening mechanism 2, and includes a first engagement element 21, a movable plate 22 and a press button 23.

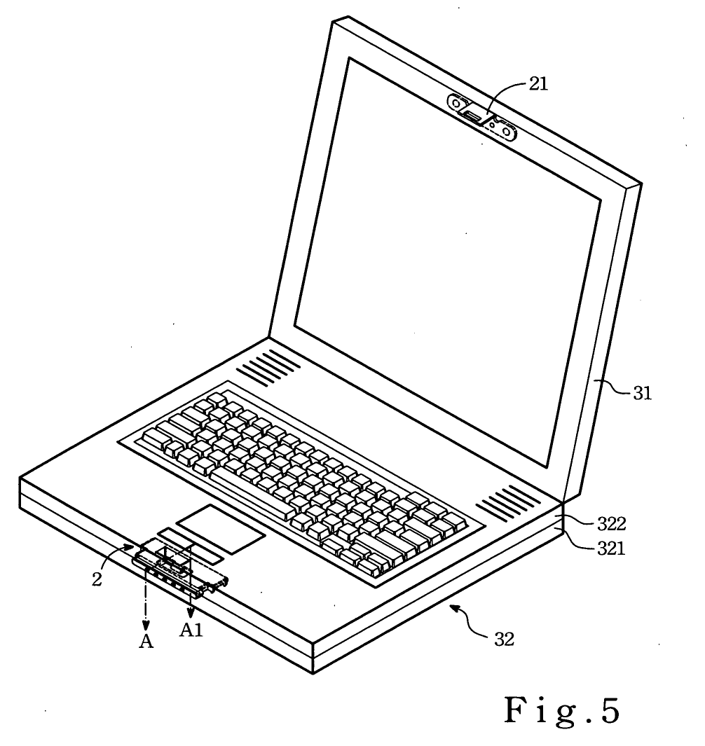

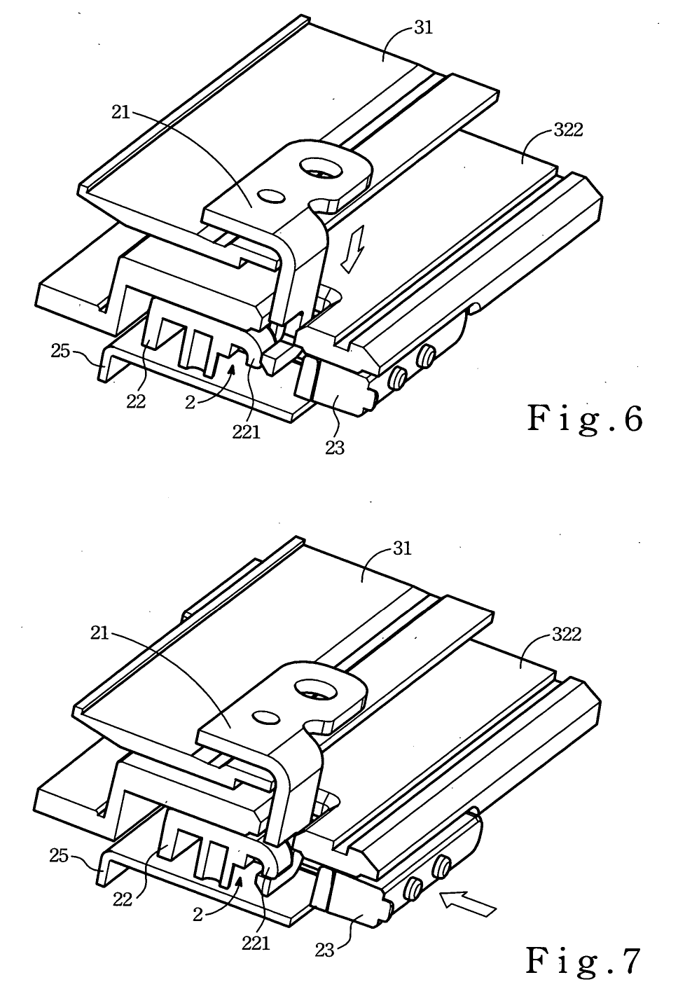

Referring to FIG. 5, the notebook computer of the present invention includes a casing 32 (hereinafter a CPU casing) and a shielding lid 31 (hereinafter will be called a display device) for covering the CPU casing 32. The fastening mechanism 2 is employed in the notebook computer of the present invention for connecting the display device 31 pivotally to the CPU casing 32. In this embodiment, in case the first engagement element 21 is fixed to the display device 31, the movable plate 22 can be disposed in the CPU casing 32. However, mounting of the first engagement element 21 and the movable plate 22 can be reversed in the other embodiment so long as the two can engage each other.

Once the display device 31 is pivoted to the CPU casing 32, the display device 31 is movable between a non-used position, in which the CPU casing 32 is covered by the display device 31 and a used position, in which the CPU casing 32 is uncovered by the display device 31. The movable plate 22 is disposed movably within the CPU casing 32, and has a second engagement element 221 for engaging with and disengaging from the first engagement element 21 when the CPU casing 32 is covered by the display device 31.

The press button 23 is separately formed from the movable plate 22 and is disposed outboard to the movable plate 22. The press button 23 is further fastened to the movable plate 22 in such a manner for synchronous movement therewith. Under this condition, inward and outward movements of the movable plate 22 together with the press button 23 with respect to the CPU casing 32 result in engagement of the first and second engagement elements 21,221 and disengagement of the first and second engagement elements 21,221. In this embodiment, the first engagement element 21 is a hasp and the second engagement element 221 is a staple for latching on the hasp, as best shown in FIGS. 6 and 7.

Since the movable plate 22 and the press button 23 are separated from each other and since only the press button 23 is exposed to the exterior of the CPU casing 32, the press button 23 is generally electroplated in order to match with the color of the CPU casing 32. In contrast to the prior art, the present movable plate 22 is not required to be coated by an anti-plating layer, thereby reducing the manufacturing cost and labor.

Note that the configuration of the press button 23 can be modified according to the demand of the clients while the remaining components of the fastening mechanism 2 remain unchanged.

An important aspect to note is that some self-lubricating materials, such as POM (polyacetal) or Nylon (PA), can be selected for forming the movable plate 22 in order to provide smooth movement of the movable plate 22. Under this condition, jamming of the movable plate 22 and the press button 23 will not occur. Since the press button 23 must undergo electroplating process, these self-lubricating materials are deleted for formation of the same.

FIG. 6 is a sectional view taken along the line A-A1 of the notebook computer shown in FIG. 5, wherein the CPU casing 32 has a bottom part 321 and an upper part 322 disposed above the bottom part 321.

The display device 31 is pivoted to the upper part 322 of the CPU casing 32, and is movable between the non-used position, in which the CPU casing 32 is covered by the display device 31, and a used position, in which the CPU casing 32 is uncovered by the display device 31.

Some electronic modules, such as processor, memory device and interface cards, are disposed within a receiving chamber defined between the upper and bottom parts 322, 321 of the CPU casing 32.

The fastening mechanism 2 includes the first engagement element 21 projecting outwardly from the display device 31, the movable plate 22 disposed movably within the CPU casing 32 and the press button 23 disposed outboard to the movable plate 22.

As shown in FIG. 6, when the display device 31 is disposed at the non-used position, the first engagement element 21 of the display device 31 extends through a hole in the upper part 322 to engage the second engagement element 221 of the movable plate 22, thereby immobilizing the display device 31 with respect to the CPU casing 32.

Referring to FIG. 7, when it is desired to use the notebook computer of the present invention, the press button 23 is pressed inward relative to the CPU casing 32, causing the movable plate 22 to retract in a rearward direction (as shown in the arrow direction). The second engagement element 221 simultaneously moves with the movable plate 22 to disengage from the first engagement element 21. Thus, the display device 31 can be turned to the use position.

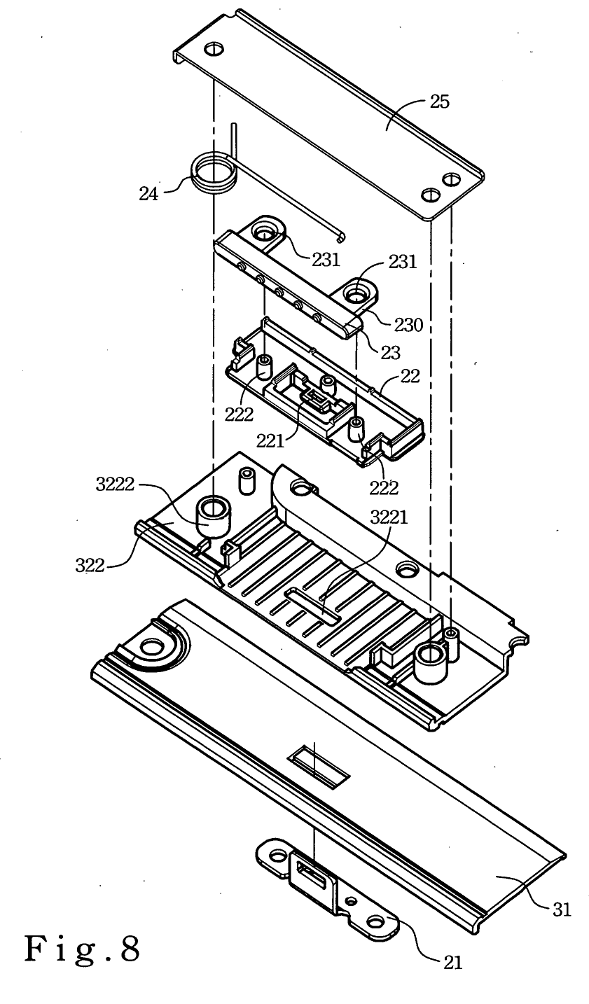

FIG. 8 shows a bottom view illustrating how the components of the fastening mechanism 2 are mounted to the display device 31 and the CPU casing 32 of the notebook computer of the present invention. The fastening mechanism 2 further includes a torsion spring 24 and a support tray 25. The press button 23 has two rear arms 230 formed with retention holes 231 while the movable plate 22 has two positioning posts 222 projecting downwardly from a lower surface thereof.

The assembly steps are as follows:
S01: the positioning posts 222 are inserted respectively into to engage the retention holes 231 in the press button 23 so as to permit synchronous movement therewith.
S02: the positioning posts 222 are fixed respectively to the peripheral walls defining the retention holes 231 in the press button 23 by heat-sealing means.

S03: the assembly of the movable plate 22 and the press button 23 is disposed on the upper part 322 of the CPU casing 32. Afterward, the intermediate section of the torsion spring 24 is sleeved on a holding tube 3222 of the upper part 322 in such a manner that one end thereof biases the movable plate 22 while the other end biasing another holding tube of the upper part 322 to provide a restoration force for the press button 23.
S04: the support tray 25 is fixed to the upper part 322 of the CPU casing 32 in order to support the movable plate 22 from below and is further connected operably to the movable plate 22 to prevent deviation of the movable plate 22 and the press button 23 during the inward and outward movements relative to the CPU casing 32.

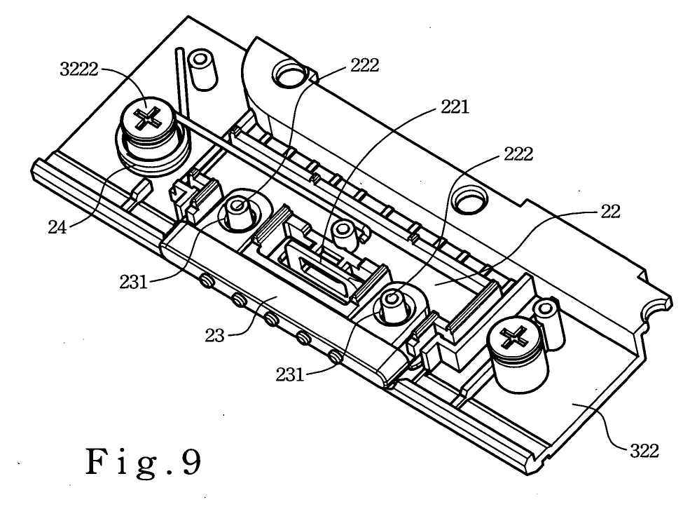

FIG. 9 is a perspective bottom view of the casing of the notebook computer of the present invention. Though a torsion spring 24 is utilized in this embodiment, any other elastomeric members with different configurations can substitute the spring 24 so long as they can provide the restoration force for the press button 23. The mounting position of the spring 24 can be at sidewise of the movable plate 22 in order to reduce the total dimension of the assembly of the movable plate 22 and the press button 23 or providing a larger distance path for the movable plate 22.

To summarize the above paragraphs, it is observable that since the movable plate 22 and the press button 23 are separately formed from each other, only the press button is electroplated, thereby eliminating the problem of selecting plating layer for the movable plate 22. In addition, the movable plate 22 and the press button can be formed by easy methods without causing extra expense. Besides, provision of the torsion spring further enhances the smooth movement of the assembly of the movable plate 22 and the press button 23. Therefore, the problem encountered in the conventional notebook computer is eliminated.

While the present invention has been described in connection with what is considered the most practical and preferred embodiments, it is understood that this invention is not limited to the disclosed embodiments but is intended to cover various arrangements included within the spirit and scope of the broadest interpretation so as to encompass all such modifications and equivalent arrangements.

What is claimed is:

1. A fastening mechanism for fastening a display device pivotally to a casing in a flip device, the fastening mechanism comprising:
a first engagement element for attachment to the display device,
a movable plate for disposing movably within the casing, and having a second engagement element for engaging with and disengaging from said first engagement element when the casing is covered by the display device, and
a press button mounted on said movable plate for synchronous movement therewith, wherein inward and outward movements of said movable plate together with said press button with respect to the casing result in engagement of said first and second engagement elements and disengagement of said first and second engagement elements.

2. The fastening mechanism according to claim 1, wherein said movable plate is made from POM (polyacetal).

3. The fastening mechanism according to claim 1, wherein said press button is disposed outboard to said movable plate, and has two rear arms formed with retention holes, said movable plate having two positioning posts respectively extending into and engaging said retention holes in the press button so as to permit synchronous movement therewith.

4. The fastening mechanism according to claim 1, further comprising a torsion spring having one end fastened to said movable plate and the other end biasing said press button to provide a restoration force thereof.

5. The fastening mechanism according to claim 1, further comprising a support tray that supports said movable plate from below and that is connected operably to said movable plate to prevent deviation of said movable plate and said press button during said inward and outward movements.

6. The fastening mechanism according to claim 1, wherein said first engagement element is a hasp and said second engagement element is a staple for latching on said hasp.

7. The fastening mechanism according to claim 1, wherein the casing is used in a notebook computer that includes a shielding lid defining the display device.

8. A fastening mechanism for fastening a display device pivotally to a CPU casing in a notebook computer, the fastening mechanism comprising:
a first engagement element adapted to be attached to the display device;
a movable plate adapted to be disposed movably within the casing, and having a second engagement element for engaging with and disengaging from said first engagement element when the casing is to be covered by the display device, and
a press button mounted on said movable plate for synchronous movement therewith, wherein inward and outward movements of said movable plate together with said press button with respect to the casing result in engagement of said first and second engagement elements and disengagement of said first and second engagement elements.

9. The fastening mechanism according to claim 8, wherein said movable plate is made from POM (polyacetal).

10. The fastening mechanism according to claim 8, wherein said press button is disposed outboard to said movable plate, and has two rear arms formed with retention holes, said movable plate having two positioning posts respectively extending into and engaging said retention holes in the press button so as to permit synchronous movement therewith.

11. The fastening mechanism according to claim 8, further comprising a torsion spring having one end fastened to said movable plate and the other end biasing said press button to provide a restoration force thereof.

12. The fastening mechanism according to claim 8, further comprising a support tray that supports said movable plate from below and that is connected operably to said movable plate to prevent deviation of said movable plate and said press button during said inward and outward movements.

13. A notebook computer comprising:
a CPU casing having a bottom part and an upper part disposed above said bottom part;
a display device pivoted to said upper part of said casing;
a fastening mechanism including
a first engagement element attached to said display device,
a movable plate adapted to be disposed movably within said casing, and having a second engagement element for engaging with and disengaging from said first engagement element when said upper part of said casing is covered by said display device,
a press button mounted on said movable plate for synchronous movement therewith, wherein inward and outward movements of said movable plate together with said press button with respect to said casing result in engagement of said first and second engagement elements and disengagement of said first and second engagement elements,
a torsion spring having one end fastened to said movable plate and the other end biasing said press button to provide a restoration force thereof, and
a support tray supporting said movable plate from below and connected operably to said movable plate to prevent deviation of said movable plate and said press button during said inward and outward movements.

14. The notebook computer according to claim 13, wherein said movable plate is made from POM (polyacetal).

15. The notebook computer according to claim 13, wherein said press button is disposed outboard to said movable plate, and has two rear arms formed with retention holes, said movable plate having two positioning posts respectively extending into and engaging said retention holes in the press button so as to permit synchronous movement therewith.
